(19) United States
(12) Patent Application Publication
(10) Pub. No.: US 2002/0085255 A1
(43) Pub. Date: Jul. 4, 2002

(54) All optical mid infrared wireless, fiber optic communication channel bridge

(76) Inventor: Moshe Gavish, Kiryat Bialik (IL)

Correspondence Address: MOSHE GAVISH, 36A Hadafna Str., Kiryat-Bialik, 27000, IL

(21) Appl. No.: 10/026,895

(22) Filed: Dec. 27, 2001

(30) Foreign Application Priority Data
Dec. 31, 2000 (IL) 140681

(51) Int. Cl. H04B 10/00

(52) U.S. Cl. 359/172; 359/154

(57) ABSTRACT

A wireless infrared communication system comprising of an optical transmitter and an optical receiver. The transmitter receives an optical signal through an optical fiber at a low infrared wavelength, amplifies this signal with Erbium Doped Amplifier (EDA) and inserts this signal to a non-linear crystal. A pump laser converts this signal to the mid infrared region and an infrared filter and lens transmit this signal to the receiver. The receiver is build from a receiving lens an infrared filter a non linear crystal to convert the mid infrared signal back to the low infrared region with a second pump laser, An EDA amplifies this signal and sends it to an optical fibber in the original low infrared wavelength for further transmission. Due to this down and up wavelength conversion the wireless link is only slightly effected by adverse atmospheric conditions and will have an all weather operation option. The system does not need to convert the signal data to electronic signals, but serves as an all optical bridge in the atmosphere in regions where optical fibers don't exist.

### BACKGROUND OF THE INVENTION.

In general the invention relates to fibber optics communication systems. In particular the invention gives a solution to problem where part of a communication line is used by two identical wavelengths or where part of a communication line is absent and IR wireless communication channel bridges the gap as an all weather solution. The system uses non-Linear crystals to transform one wavelength to another in both directions dawn and up.

Wireless optical communication serves today as a connection between local and wide Area networks. A wireless link in the near infrared and designed for a range of 6000 meters will have a range of 450 meters in thick fog and 200 meters in clouds due to Atmospheric attenuation. A wireless system working in the 10 micron region can keep an all weather link for the total design range. While it is possible to convert the information to electronic form and then transmit this information at 10 microns to a second station equipped with a 10 micron detector and then transform this information to electronic signals and transmit those signals in the near infrared 1.5 microns region to the next fiber, this transformations are very complicated if we want to keep the whole bandwidth range of the information. Both infrared sources and detectors are very expensive noisy and need cryogenic cooling. Link quality and cost becomes very large. An alternative solution used today is to use millimeter wave communication, but this region is crowded needs licensing and is also expensive.

A different problem that the present invention can solve is when two identical wavelengths arrive at the same fibber connecting two locations. One of them needs to be changed to a different wavelength that the fibber can carry. Once the common line is separated the information is returned to the original wavelength.

The present invention is based on an all optical solution. The near infrared signal at frequency w1 together with a pump frequency wp will produce an output frequency w2 in the middle infrared, where w2=wp−w1. This operation called Difference Frequency Generation happens in a non linear crystals as for example GaAs, LiNbO3 and more.

Recently much work has been done in frequency conversion into mid-IR using Quasi phase matched GaAs (1,2) Yoo has converted 10 Gb/s information at a low bit error rate with negligible cross-talk. (2). U.S. Pat. No. 5,434,700 By Yoo gives several methods of non-linear crystal structures of difference frequency conversion. The opposite direction frequency up-conversion where a signal from the mid infrared frequency w1 is transformed to a high frequency w2 by mixing it with a strong wp, where w2=w1+wp was used for many years to avoid using slow and noisy detectors in the mid infrared. Here again we need a non-linear crystal like for example Ag3AsS3 which is transparent at all 3 wavelength. We prefer to perform the up conversion in the difference frequency mode here w2=wp−w1 if wp>w1,w2 and we can obtain the quasi phase matching condition. In this method we use the same high efficiency GaAs converter to perform the opposite conversion.

### SUMMARY OF THE INVENTION

The general objective of the invention is provision of a method and apparatus for an all optical mid infrared wireless communication, all weather bridge, of a fibber optic communication network. According to the invention each terminal of the fiber optical gap will have dawn and up conversion crystals that will send the signal in the mid infrared region through the atmosphere and return the received signal to the working wavelength. Each unit will be able to receive and transmit radiation simultaneously. Each non linear conversion crystal will have its own pump laser and infrared optics, but use of some of the optical components by both channels is possible. Each channel can have some optical filters, beam splitters etc. and might include also optical amplifiers to compensate for conversion losses. The non-linear crystal might be a single crystal or built from alternate layers in the QPM structure, where each crystal has a coherence length thickness.

The system as described above does not have any electronic components for converting the optical signal to electronic form or the electronic signals to optical form. The system uses the already present infrastructure of the fiber optic communication channels to make the optical to electrical signal conversion. Another advantage of the present invention is to start with a first wavelength 11 and to exit at a different wavelength 11′ by using a different pump wavelength at transmitter and receiver. This change of wavelength is a solution to wavelength collision on the same fiber.

### BRIEF DESCRIPTION OF THE DRAWINGS

FIG. 1. Block diagram of main components of difference frequency generation subsystem this part is in the transmit side of fiber to wireless transform.

FIG. 2. Block diagram of main components of frequency up conversion subsystem, this part is in the receiver side of the wireless to fiber transform.

FIG. 3. Block diagram that includes main components of the mid-infrared wireless bridge according to preferred embodiment of the present invention.

### DETAILED DESCRIPTION OF THE INVENTION

Before describing the processes of difference frequency generation and frequency up conversion according to the present invention, we shall review some of the laws governing those non linear processes.

1. conservation of energy—w1+w2=w3.

2. conservation of momentum—k1+k2=k3

3. The output power is proportional to signal input power, pump power, non linear optical coefficient and crystal length.

4. To get high conversion efficiency the non-linear crystal must be transparent to all wavelengths involved.

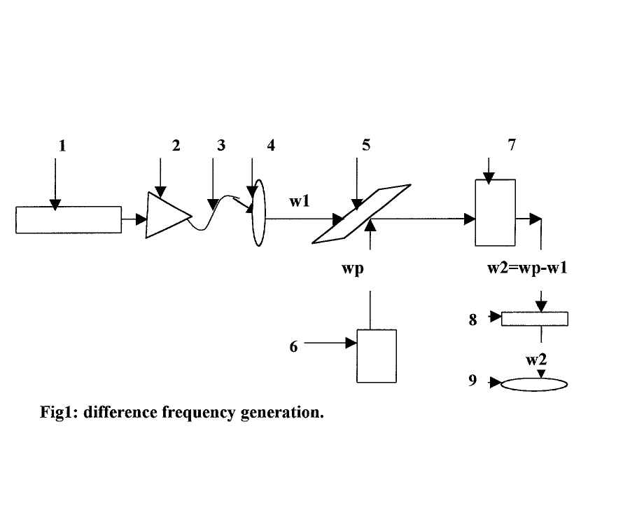

FIG. 1. shows the difference frequency generation part. The signal laser 1 transmits the information through an optical fiber which enters the down conversion unit. Before performing the down conversion the signal is amplified by an Erbium doped fiber amplifier 2, this amplification should compensate for the losses of the non linear conversion process. The amplified signal travels in the fiber 3 and is concentrated by lens 4 on the non linear crystal 7. The pump laser 6 is directed to same crystal by the dichroic beam splitter 5. Both signal and pump beam move in the non linear crystal in the same direction and in the same cross sectional area. The non linear crystal can be a single crystal or a quasi phase matched crystal, made of alternating layers of crystals that have a coherence length thickness.

The output radiation of the crystal contains all three wavelengths. A filter 8 separates those wavelengths and transmits only the infrared radiation. This radiation is collimated by lens 9 and is directed as an mid infrared radiation towards the receiver. As an example when the pump wavelength is in the 1.3 micron region and the signal in the 1.5 micron region, the difference frequency will give an output at the 10 micron region.

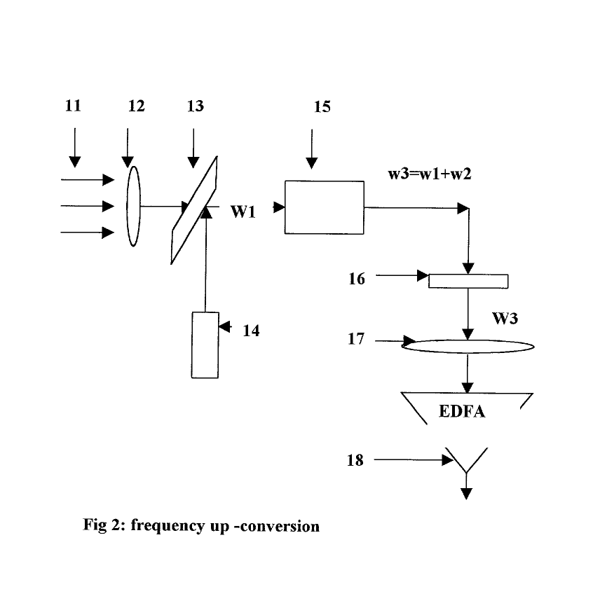

FIG. 2 shows a frequency up-conversion unit. The incoming infrared radiation 11 is concentrated on a non-linear crystal 15, which might be a different crystal than the down converting crystal. The dichroic beam splitter 13 directs both the incoming radiation w1 and the second pump radiation w2 14 towards a small area of the non linear crystal Crystal 15 is transparent to both w1,w2 and the sum w1+w2=w3 which is in the near infrared region. The filter 16 separates w3 from w1 and w2. The w3 radiation emerging from the filter is focused a second EDFA to compensate for conversion losses and then travels on the optical fiber to close the bridge of the optical network.

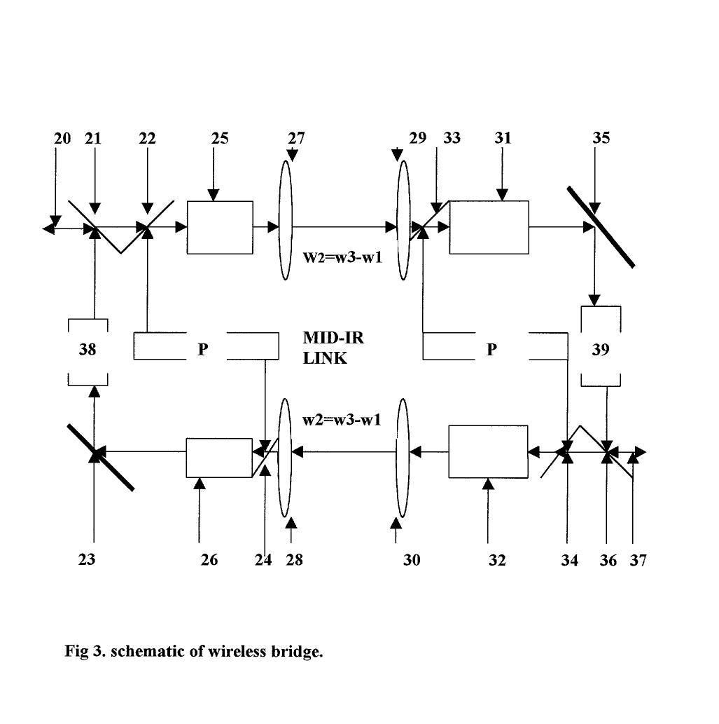

FIG. 3 shows the whole wireless bridge of the preferred embodiment of the invention. It contains two parallel wireless sections , one from fiber 20 to output fiber 37 and the other in the opposite direction from fiber 37 to fiber 20. In the preferred embodiment both up and down conversion are performed by a QPM difference frequency conversion. Both up and down conversion use the same pump laser, whose energy is divided between the signal and idler energy. While in the down conversion both signal and pump are in the near infrared region and idler is in the mid infrared region, in the up conversion the signal is in the mid infrared the pump and idler are both in the near infrared region. The same type of QPM non linear crystal can perform the difference frequency conversion, but different crystal perform the conversion. Beam splitter 21 serves to couple the received signal from mirror 23 to fiber 20 and to transmit signal from fiber 20 to non linear crystal 25. Isolators 3 8 are added to reduce cross talk between incoming signals and out going signals. Dichroic beam splitters 22, 34 couple the signal and pump energy to the crystals, crystals 25, 28, 31, 32 are four similar non linear QPM crystals, Lenses 27, 29, 28, 30 are four mid infrared lenses for the wireless channel. Other optical components like filters and some other converging lenses and power supplies for the pump lasers are not shown in this FIG. 3. Although the preferred invention uses DFG for both down and up conversion, the invention is not limited to DFG and the up conversion can be made as a sum frequency w2=w1+w3, where pump frequency and crystals differ in the up and down conversion. Although the preferred embodiment uses QPM crystals , the periodic electric field poling of a single crystal can be used providing crystals with appropriate size and optical properties like AgGa Se2 are used. As is known a waveguide of for example 20 micron width can be generated on the crystal to concentrate the radiation density and improve non linear efficiency.

We claim

1. An all optical wireless communication system including: A transmitter that receives wavelength 11 and down converts it to wavelength 12>11 for transmission through the atmosphere. A receiver where the radiation 12 is up converted back to wavelength 11. The transmitter and receiver include a non-linear crystal, a laser pump and collimating optics.

2. A system like in claim 1 where the non-linear elements are formed from quasi-phase matched crystals sintered together.

3. A system like in claim 1 that includes both transmitter and receiver elements in each side of the transmission range.

4. A system like in claim 1 where same crystal, same pump laser or same optics are used for the up and down conversion functions.

5. A system like in claim 1 where 11 is in the near infrared and 12 is in the mid Infrared. wavelength.

6. A system like in claim 1 where 11 is in the near infrared and 12 is in the Thz wavelength atmospheric channel.

7. A system like in claim 1 where the down conversion is performed by the difference frequency generation and the up conversion is performed by the sum frequency generation.

8. A system like in claim 1 but with output wavelength 12 not equal to 11, but shifted to a different wavelength.
